(19) United States
(12) Patent Application Publication
(10) Pub. No.: US 2004/0250275 A1
(43) Pub. Date: Dec. 9, 2004

(54) Dynamic menus for DVDs

(75) Inventor: Stuart Anthony Green, Sheffield (GB)

Correspondence Address: WILMER CUTLER PICKERING HALE AND DORR LLP, 60 STATE STREET, BOSTON, MA, 02109, US

(73) Assignee: Zoo Digital Group plc

(21) Appl. No.: 10/457,265

(22) Filed: Jun. 9, 2003

(51) Int. Cl. G06F 13/00

(52) U.S. Cl. 725/37; 386/83

(57) ABSTRACT

Embodiments of the present invention allow dynamic menus comparable or substantially similar to those used in computer applications to be realised and implemented using, for example, a conventional DVD and conventional DVD player.

### FIELD OF THE INVENTION

The present invention relates to a data processing system and method, a computer program product and an audio-visual product and, more particularly, to a DVD product authoring system and method, a computer program product for such an authoring system and method and a DVD product.

### BACKGROUND TO THE INVENTION

DVDs represent one of the fastest growing forms of multimedia entertainment throughout the world. Conventionally, DVDs have been used to present movies to users using extremely high quality digital audio/visual content. FIG. 1 shows, schematically, a typical home entertainment system 100 comprising a DVD player 102, a DVD 104 and a television 106. The DVD 104 contains a number of programs and cells 108 each of which comprises corresponding digital audio-visual content 110 together with respective navigation data 112. The navigation data 112 is used by a navigation engine 114 within the DVD player 102 to control the order or manner of presentation of the digital content 110 by a presentation engine 116. The presentation engine 116 presents the digital content 110 on a television or monitor 106 as rendered audio-visual content 118. As is well known within the art, the rendered audio-visual content 118, conventionally, takes the form a movie or photographic stills or text associated with that movie; so-called Bonus features.

A user (not shown) can use a remote control 120 associated with the DVD player 102 to influence the operation of the navigation engine 114 via an infrared remote control interface 122. The combination of the infrared remote control 120 and the navigation engine 114 allows the user to make various selections from any menus presented by the presentation engine 116 under the control of the navigation engine 114 as mentioned above.

Due to the relatively limited set of commands that might form the navigation data, the processing performed by the DVD player and, in particular, the navigation engine 114, is relatively simple and largely limited to responding to infrared remote control commands and retrieving and displaying, via the presentation engine 116, pre-authored or pre-determined digital audio-visual content 110. Beyond decoding and presenting the digital audio-visual content 110 as rendered visual content 118, the DVD player 102 performs relatively little real-time processing.

This can be contrasted with the relatively sophisticated real-time processing performed by computers when providing or supporting a graphical user interface (GUI) such as that represented or presented by all of the members of the family of Windows operating systems available from Microsoft Corporation. FIG. 2 depicts, schematically, a GUI 200 presented by, for example, Internet Explorer, running on the Windows 98 operating system. The GUI 200 comprises an application window 202 with a menu bar 204. The menu bar 204 has a number of menu items 206 to 216 that can be selected individually using a mouse and cursor or corresponding hot-keys as is well known within the art. Selecting one of the menu items 206 to 216, typically, causes a pull-down menu to be displayed. FIG. 3 depicts a pull-down menu 300 corresponding to the “File” menu item 206. It can be seen that the pull-down menu 300 comprises a number of further menu items, “New” 302 to “Close” 304, that can be selected to perform corresponding functions. Two of the further menu items; namely, “New” 302 and “Send” 306 invoke or produce further, respective, menus (not shown)

As will be appreciated, the menu items are selected and the various menus, pull-down or otherwise, are invoked in real-time, that is, the processing necessary for displaying and stepping through the various menu items presented is performed in real-time. Effectively, the instruction set of a microprocessor of a host computer is sufficiently sophisticated and flexible to imbue the Internet Explorer application 200 with the capability to perform the necessary calculations and manipulations to implement the display and selection of menu items in response to user commands issued in real-time.

It will be appreciated that this is in stark contrast to the operation of menus and the selection of menu items using current DVD players. As compared to computer applications, the menu options and the mode of presentation of those options of those DVD players is currently relatively crude and unsophisticated. This is, at least in part, due to most DVD players being unable to perform, in response to a user action or command, the real-time processing necessary to display such sophisticated menus and, subsequently, to select a menu item from such displayed menus. This is due, in part, to the very limited additional graphics element processing capacity offered by current DVD players.

It will be appreciated that the panes illustrated in FIGS. 2 and 3 have been shown as lacking content. The limitations of DVD players become even more apparent when considering providing dynamic menus with content that can change or is dynamic. For example, the content displayable within a pane might be video or stills of digital images such as photographs or the like.

It is an object of embodiments of the present invention at least to mitigate some of the problems of the prior art.

### SUMMARY OF INVENTION

Accordingly, a first aspect of embodiments of the present invention provides an asset authoring method comprising the steps of providing a data structure comprising data defining a menu structure having at least one menu having a respective number of menu items associated with a number of defined views of, or actions in relation to, a general visual asset; providing a visual asset; and creating, automatically, a number of visual assets using at least one of the visual assets provided and the data of the data structure; the visual assets created corresponding to respective views of the defined views of the visual asset provided or reflecting respective actions of the defined actions in relation to the visual asset provided.

Advantageously, embodiments of the present invention allow menus, in particular, pull-down menus, associated with viewing content to be realised on a DVD player, that is, the embodiments allow the real-time display of menus and invocation of menu items performed by computers to be at least emulated.

A further aspect of embodiments of the present invention provides a method of authoring visual content; the method comprising the step of creating a video sequence comprising data to display a progressively expanding menu comprising a number of menu items following invocation of a selected menu item or a user-generated event. A still further aspect of embodiments of the present invention provides a method of authoring visual content; the method comprising the step of creating a video sequence comprising data to display a progressively contracting menu comprising a number of menu items following invocation of a selected menu item or a user generated event.

Other aspects of embodiments of the present invention are described herein and claimed in the claims.

### BRIEF DESCRIPTION OF THE DRAWINGS

Embodiments of the present invention will now be described, by way of example only, with reference to the accompanying drawings in which:

FIG. 1 shows a home entertainment system;

FIG. 2 shows a GUI for Internet Explorer;

FIG. 3 depicts a pull-down menu of the GUI;

FIG. 4 shows schematically an asset authoring process according to an embodiment of the present invention;

FIG. 5 depicts a data structure for defining a menu according to an embodiment;

FIG. 6 shows, schematically, video sequences for expansion and contraction of pull-down menus according to embodiments of the present invention;

FIG. 7 illustrates data for a pull-down menu to be used in the video sequences of FIG. 6;

FIG. 8 illustrates the generation of sub-picture menu data for the pull-down menus used in the video sequences of FIG. 6;

FIG. 9 depicts the display of the frames of the video sequences together with the schematic overlay of the sub-picture menu data;

FIG. 10 shows the relationship between a sub-picture having menu item overlays and a corresponding video sequence or frame;

FIG. 11 illustrates the frames of a video sequence for the expansion and contraction of the further menu;

FIG. 12 illustrates the generation of a further menu item according to an embodiment;

FIG. 13 shows menu data for generating a video sequence showing the progressive expansion or contraction of the further menu shown in FIG. 12;

FIG. 14 depicts the relationship between a graphical overlay of a sub-picture to a corresponding menu item of the further menu shown in FIG. 12;

FIG. 15 shows a first flowchart for generating a visual asset according to an embodiment; and

FIG. 16 shows a second flowchart for generating a visual asset according to an embodiment.

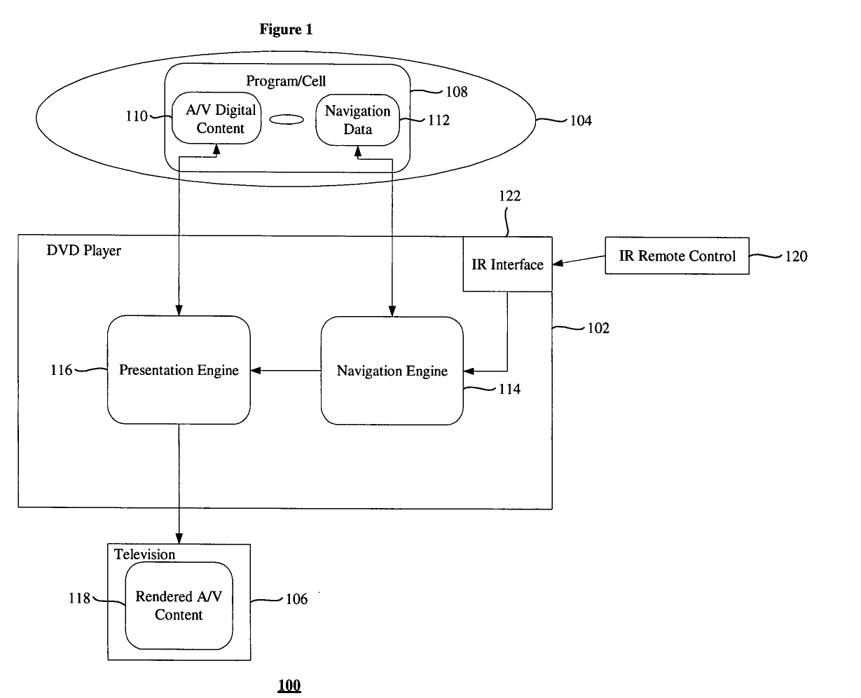

### DESCRIPTION OF PREFERRED EMBODIMENTS

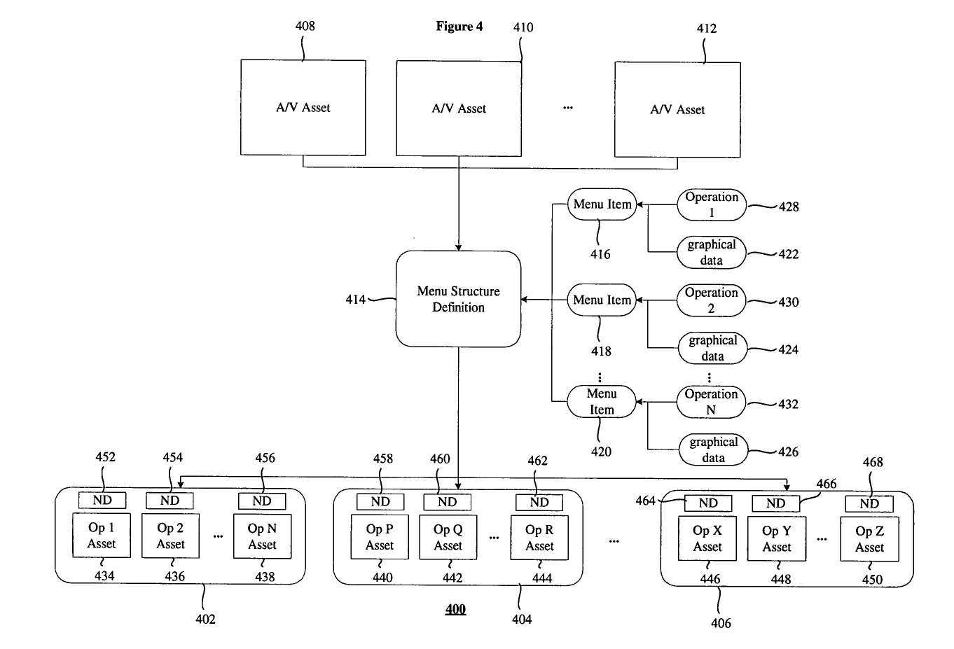

FIG. 4 shows an authoring process 400 according to an embodiment of the present invention for automatically producing a number, M, of sets of assets 402 to 406 from corresponding assets 408 to 412 and a data structure 414 defining a menu structure having a number, N, of menu items 416 to 420. The menu items, or only selected menu items, if appropriate, have associated data 422 to 426 representing a graphical manifestation or representation of the menu items. Also, the menu items, or only selected menu items, have associated data processing operations that perform, or at least provide access to functions that can perform, data processing operations or manipulations upon the provided assets 408 to 412 to produce the sets of assets 402 to 406.

It can be appreciated that the sets of assets 402 to 406 comprise respective assets. For example, the first set of assets 402 comprises several visual assets 434 to 438 that were produced, from the first asset 408, by applying appropriate or selected operations of the available operations 428 to 432 according to the menu structure, that is, according to whether a menu item is intended to be available for that first asset 408. The assets 434 to 438 created are shown, for the purpose of a generalised description, as having been created from menu items that have operations A, B and C (not shown) associated with them. The operations A, B and C will be operations associated with corresponding menu items selected from the N illustrated menu items.

Similarly, the second set of assets 404 comprises several assets 440 to 444 that were produced, from the second asset 410, by applying appropriate or selected operations of the available operations 428 to 432 according to the menu structure, that is, according to whether a menu item is intended to be available for that second asset 410. The assets 440 to 444 created are shown, for the purpose of a generalised description, as having been created from menu items that have operations P, Q and R (not shown) associated with them. The operations P, Q and R are associated with corresponding menu items selected from the N illustrated menu items. The same applies to the Mth set of assets 406, which comprises respective assets 446 to 450 produced from the Mth asset 412 and selected operations 428 to 432.

Navigational data 452 to 468 is also created for each asset 434 to 450. The navigational data is arranged to allow the navigation engine 114 of the DVD player 102 to obtain the next image or video sequence, that is, created asset, according to the menu structure. For example, if the first asset 434 of the first set of assets 402 represents an image, the navigational data associated with that first asset 434 may comprise links to the second asset 436, which might represent an image or video sequence showing that image together with the progressive display of a number of menu options associated with that image. For example, the menu options might relate to image processing techniques such as “posterising” the image. Therefore, in this example, the links associated with the second asset 436 might comprise a link to a third asset (not shown) representing the image together with the progressive closing or contraction of the menu options previously displayed via the first asset 434 and a link to a fourth asset showing a “posterised” version of the original image shown in the original asset 408.

It will be appreciated that the assets might represent stills or video sequences. In preferred embodiments, the assets that relate to the menu options or menu items are video sequences that show the progressive expansion or contraction of the menus. Alternatively, or additionally, the assets might comprise two portions with a first portion representing a video sequence arranged to display or hide the dynamic menu and a second portion representing a still image or a further video sequence that is arranged to loop, that is, that is arranged to repeat once the menu has been displayed or hidden.

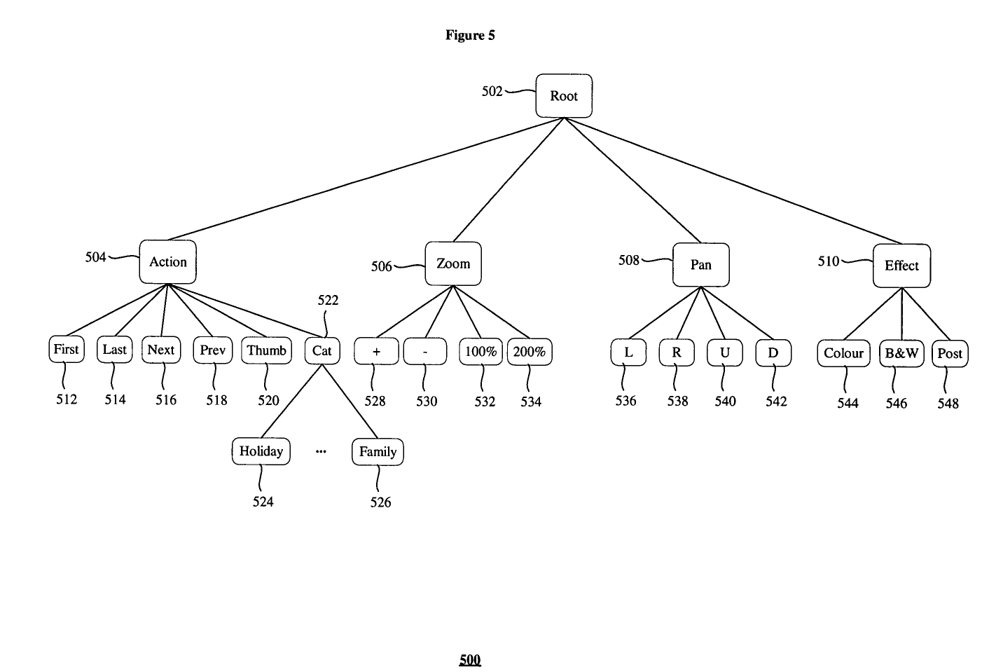

FIG. 5 illustrates graphically a possible menu structure definition in the form of a tree 500. The data structure will be described with reference to a menu structure to perform image-processing techniques on a number of images. It will be appreciated that this is for the purpose of illustration only and that embodiments of the present invention are not limited thereto. The tree 500 comprises a root node 502 at which an asset might be displayed in its original or unadulterated form. Selecting “OK”, for example, using the remote control 120, might be intended to cause a transition to a node for displaying the menu options available at that level in the menu structure. It can be appreciated from the example that invoking the “OK” button or the like is intended to produce a pull-down menu having four menu items 504 to 510. In the example, the four menu items are “Action” 504, “Zoom” 506, “Pan” 508 and “Effect” 510. At this stage in the menu structure, an originally displayed asset will be intended to also comprise a pull-down menu showing those options with those menu options having been progressively displayed via a corresponding video sequence. In order to select the menu options, sub-picture data is intended to be generated shown graphic overlays for each of the menu items “Actions” 504, “Zoom” 506, “Pan” 508 and “Effect” 510.

It can be appreciated that the menu structure is defined such that selecting the first menu option 504 produces a further menu comprising a number of sub-menu items. In the illustrated example, the sub-menu items are “First” 512, “Last” 514, “Next” 516, “Previous” 518, “Thumbs” 520 and “Category” 522. Again, the menu structure is arranged to have sub-picture graphic overlays associated with each of the options that can be used to select the options. Video assets are intended to be produced that give effect to operations associated with these options 512 to 522.

Selecting the “First” 512 option is intended to display a first image of a number of images. Therefore, an asset displaying that first image is intended to be produced. Selecting the second option, “Last” 514, is intended to display the last image of the number of images. Therefore, an asset for displaying that image will be produced using the last image. The “Previous” 516 and “Next” 518 menu items are intended to display previous and next images respectively. Suitably, video assets giving effect to the display of the previous and next images are intended to be created. The option “Thumbs” 520 is intended to display thumbnail views of all, or selectable, images within a category or set of images. Again, selecting this option will necessitate producing a video asset that displays all of the thumbnail views or a selected number of those thumbnail views. It can be appreciated that any view of an asset might need associated navigation data to jump to the video asset or sequence showing the thumbnail views. The final option, “Category” 522, is arranged to present a further sub-menu containing a number of categories of image; each represented by a corresponding menu item 524 to 526. Selecting one of these menu items is intended to display the first image in the category of images or a number of thumbnail views of the images within that category.

The menu structure might be defined such that the second menu item, “Zoom” 506, produces a further menu having four zooming options; namely, “+” 528, “−” 530, “100%” 532 and “200%” 534, which, when selected, are intended to produce zoomed versions of an original asset. Suitably, giving effect to invocations of these menu items 528 to 534 will require corresponding video assets, firstly, to display the menu options and, secondly, to give effect to the transition from an initial, or starting, view of an asset to a zoomed view of the asset together with corresponding navigation data to allow the navigation engine 114, in conjunction with the presentation engine 116, to retrieve and render the video assets showing such zooming operations. Again, a sub-picture having appropriately positioned graphical overlays that are selectable and maskable will also be desirable.

The “Pan” 508 menu option produces a further sub-menu comprising four menu items or options 530 to 542 that are arranged to allow a user to pan around an image. Accordingly, for each original asset, various video assets need to be defined that support such panning. Similarly, the final menu option, “Effect” 510, is arranged to produce a further sub-menu comprising three menu items 544 to 548 that apply image processing techniques or effects to the original assets. The illustrated menu items are “Colour” 544, “Black & White” 546 and “Posterise” 548, which require video assets to present the original assets in colour, in black and white and in a posterised forms respectively. Again, sub-picture image data would also be required to support selection of the menu items 544 to 548.

It will be appreciated that the assets produced, or intended to be produced, to give effect to traversing the menu structure and invoking menu items can be still images or video sequences representing a dynamic transition from one view of an asset to another view of an or the asset or representing a transition between views of an asset.

It can be appreciated from the above that marshalling or producing the assets in preparation for creating a DVD that uses, or at least emulates, dynamic menus requires a very large number of assets to be created that anticipate all possible combinations of asset views according to the number of menus and menu options or items within those menus defined in the data structure. Furthermore, corresponding assets that show the expansion or contraction of the menu items either jointly or severally with respective asset data will also require a large number of assets to be generated.

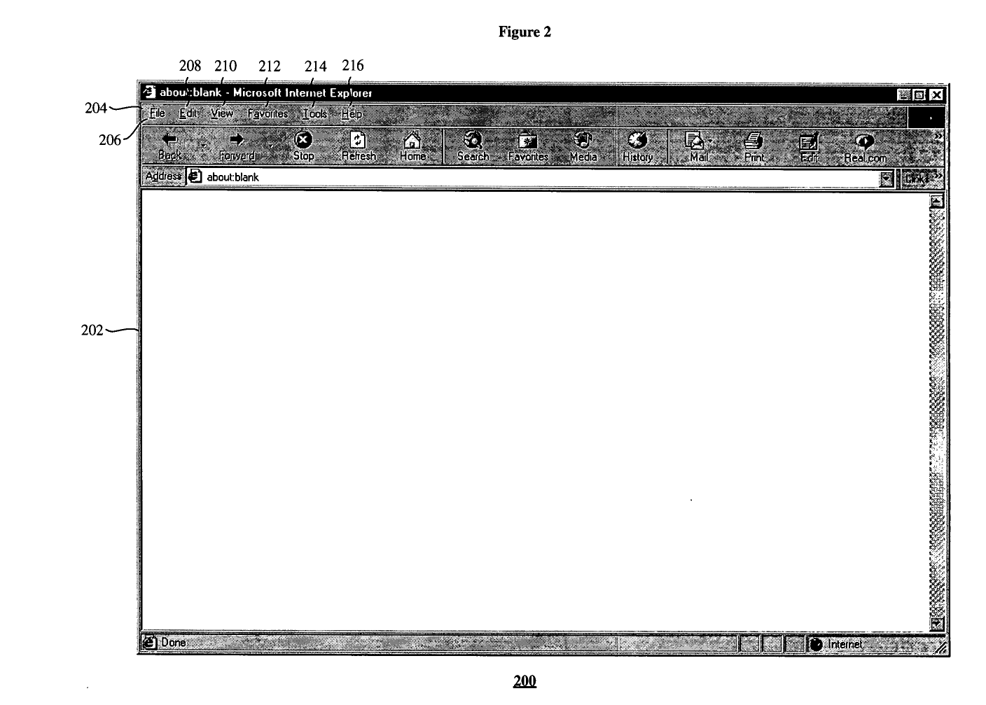

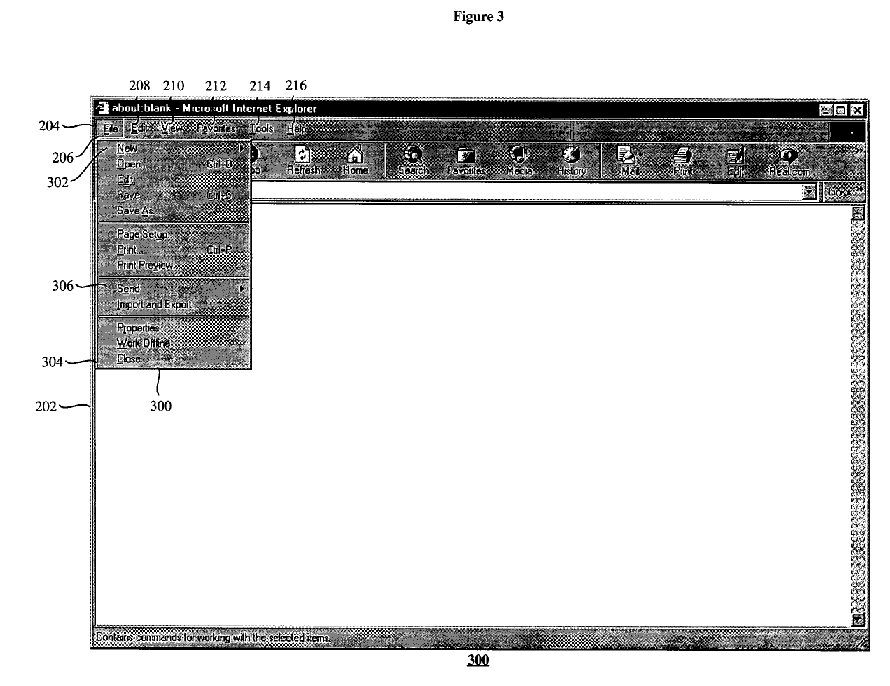

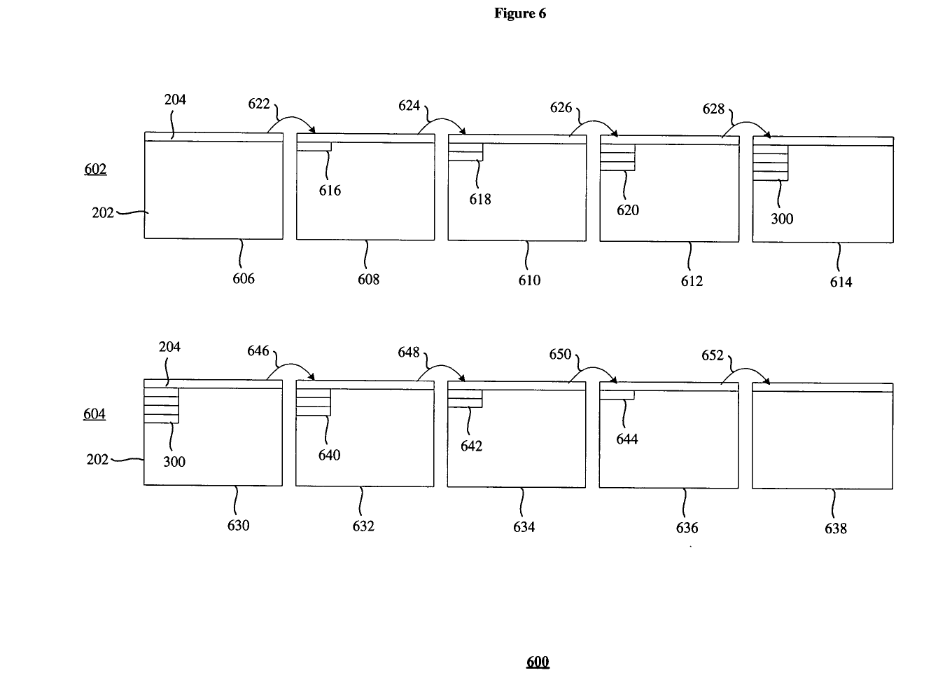

Referring to FIG. 6, there is shown schematically an authoring process 600 for producing a pair of video sequences 602 and 604 comprising frames that illustrate the expansion and contraction of a pull-down menu, assuming that the menu structure and menu items are arranged to define a pull-down menu. The first video sequence 602 has been shown, for illustrative purposes only, as comprising five frames 606 to 614. The first frame 606 is a schematic representation of the image shown in FIG. 2. In the interests of clarity, only the menu bar 204 and window 202 of the image of FIG. 2 have been illustrated in each frame. The second frame 608 is shown with a portion 616 of the pull-down menu 300 having been displayed. It can be seen that the third and fourth frames 610 and 612 respectively illustrate progressively larger portions 618 and 620 of the pull-down menu 300. The final frame 614 illustrates the complete pull-down menu 300 and corresponds to the image shown in FIG. 3. The progressively increasing or expanding portions 616 to 620 of the pull-down menu 300 are illustrated as expanding on a per menu item basis, that is, each portion contains a greater number of menu items as compared to a previous portion. Again, for the purpose of clarity of illustration only, the pull-down menu 300 has been shown as comprising four menu items rather than the full 13 menu items shown in FIG. 3. However, it will be appreciated that a pull-down menu, according to requirements, may present any predetermined number of menu items. The progressive expansion and contraction of the menus corresponds to or emulates revealing or hiding of menus within a Windows context.

Although FIG. 6 illustrates the creation of individual frames, it will be appreciated that in preferred embodiments the visual assets 606 to 614 will take the form of a number of frames, that is, video sequences. For example, visual asset 606 will, in practice, represent a video sequence comprising a number of frames that progressively displays the first portion 616 of the menu over a predetermined period of time. It will be appreciated that the number of frames constituting such a video sequence might be a function of the desired display speed for the menu.

Navigation data 622 to 628 provides links between video assets and allows the navigation engine to retrieve the first video sequence or set of video assets or sequences 602 from the DVD 104 and to cause the presentation engine 116 to display the first video sequence using that retrieved data.

The second video sequence 604 of FIG. 6 has also been shown, for illustrative purposes only, as comprising five frames 630 to 638. The first frame 630 is a schematic representation of the image shown in FIG. 3, in which the pull-down menu 300 is in its fully expanded form. The second frame 632 is shown with a smaller portion 640 of the pull-down menu 300 having been displayed. It can be seen that the third and fourth frames 634 and 636 respectively display progressively smaller portions 642 and 644 of the pull-down menu 300. The final frame 638 illustrates the complete pull-down menu 300 in its most contracted form and corresponds to the image 200 shown in FIG. 2. The progressively decreasing or contracting portions 640 to 644 of the pull-down menu 300 are illustrated, again, as contracting on a per menu item basis, that is, each portion contains progressively fewer menu items as compared to a previous portion. Navigation data 646 to 652 linking each video asset will also be created to allow the navigation engine 114 to retrieve the asset and cause the presentation engine 116 to display that video asset. Again, it will be appreciated that each video asset 630 to 638 will, in practice, represent a video sequence and that the embodiment described above has been illustrated using frames rather than sequences for the purposes of clarity of illustration only.

It will be appreciated the video content panes of the video sequences 602 and 604 have been shown “empty” for the purposes of clarity only. In practice, the content panes will contain content such as, for example, image data or video sequence data.

It will be appreciated that although the pull-down menu has been described with reference to expanding and contracting on a per menu item basis, embodiments can be realised in which any predetermined expansion or contraction step size is used. It will be appreciated that smaller or greater steps sizes might affect the number of frames that are required to form the first 602 and second 604 video sequences or the smoothness of the display of the pull-down menu 300. It can be appreciated that rendering such pre-authored video sequences as the first 602 and second 604 video sequences enables pull-down menus to be provided, or at least emulated, using DVD players, which increases the richness of the user interfaces for, and the user experience, of DVDs.

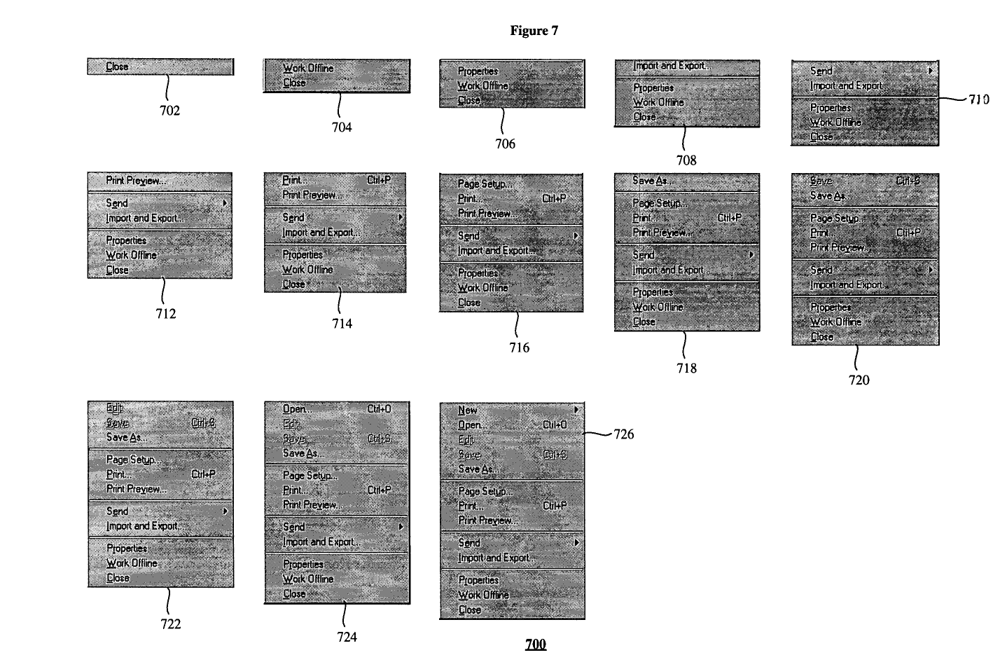

FIG. 7 shows, schematically, the graphical data 700 that can be used to produce a progressively expanding or contracting pull-down menu 300 according to an embodiment. It can be seen that the data 700 comprises 13 pull-down menu portions 702 to 726. These portions 702 to 726 are used to produce the video sequences 602 and 604 described above with respect to FIG. 6. A complete frame of video may comprise both the pull-down menu portions or complete menu with or without the “application” window, such as that displayed in FIG. 2, together with other data or information such as, for example, content for the application window and/or a background on which the application window sits, if it does not occupy the whole of the 720×480 or 720×576 pixels of the DVD NTSC and the DVD PAL/SECAM pixel resolutions, respectively.

The data representing the video sequences 602 and 604, stored on the DVD 104, will also be accompanied by sub-picture data, carried by at least one of the thirty-two available sub-picture streams. The sub-picture data is used to produce graphical overlays or highlights for selected menu items of the various menu items of the pull-down menu. The sub-picture data is used to produce a bitmap image bearing graphical overlays that are displayed on top of, or otherwise combined with, corresponding video sequences. The manner and position of display of the graphical elements are controlled or determined using corresponding sub-picture buttons with associated highlights that are selectively operated as masks to hide or reveal an associated graphical overlay.

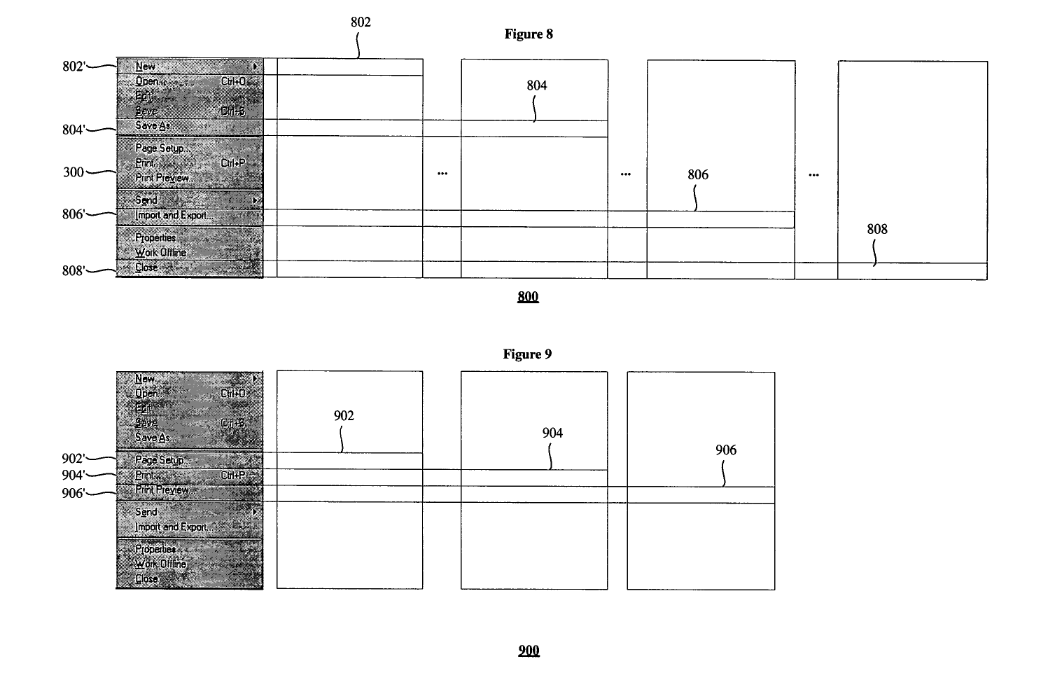

Referring to FIG. 8, there is shown schematically the relationship 800 between a selected number of graphical overlays 802 to 808 and corresponding portions 802′ to 808′ of the pull-down menu 300. The sub-picture buttons or masks associated with each graphical overlay 802 to 808 are arranged such that, when invoked in conjunction with the video sequence displaying the pull-down menu, the sub-picture bitmaps selectively highlight or overlay the corresponding portions 802′ to 808′ of the pull-down menu 300. The presentation engine 116, under the control of the navigation engine 114, displays the appropriate sub-picture graphical overlay 802 to 808 in response to user commands received from the remote control 120 using the sub-picture buttons or masks. For example, FIG. 9 illustrates the relationship 900 between three central graphical overlays 902 to 906 of a sub-picture (not shown) and their corresponding menu items 902′ to 906′. Assume that the central graphical overlay 904 is currently displayed. The navigation engine 114, in response to an “up” or “down” user command received from the IR control 120, will cause the presentation engine 116 to display a selected overlay 902 or 906 to highlight the “Page Setup” 902′ or “Print Preview” 906′ menu items respectively by masking the appropriate overlays that are not required to be displayed.

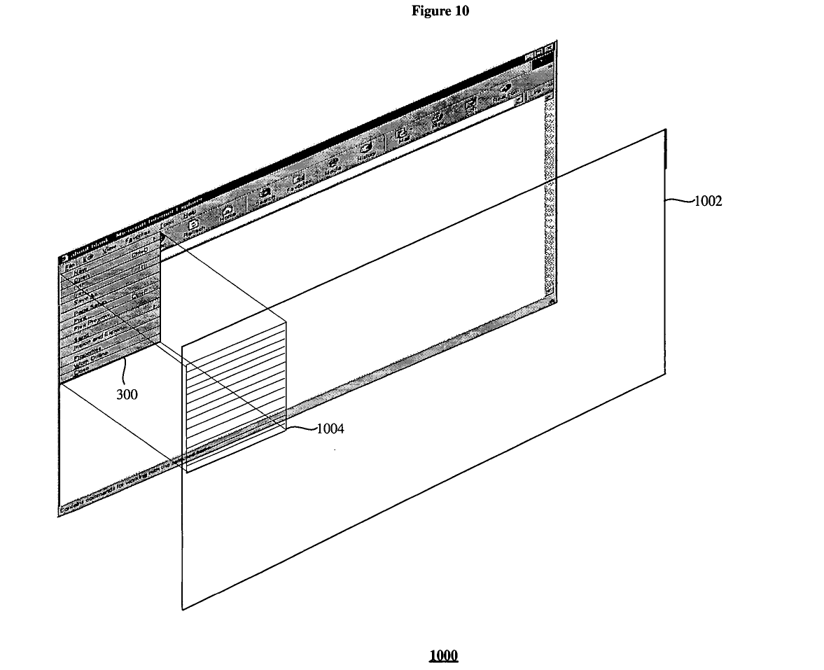

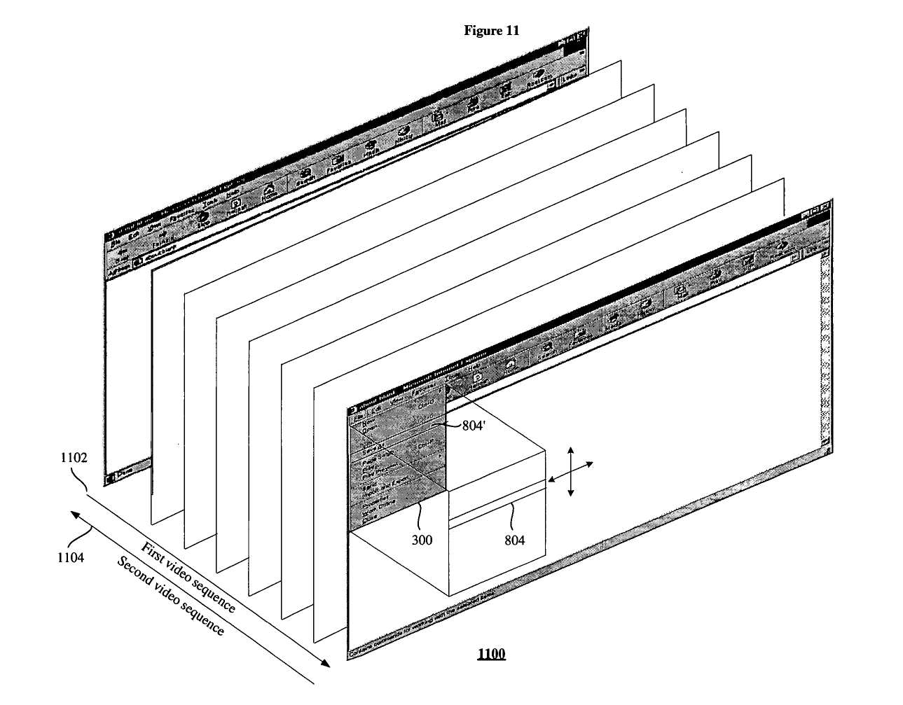

Referring to FIG. 10, there is shown the relationship 1000 between a sub-picture 1002 containing graphical overlays 1004 and a video sequence or frame containing the pull-down menu 300 in its fully expanded state. The sub-picture is notionally divided into a number of regions (not shown) known as buttons that can be selectively displayed in response to user actions, that is, commands received from the IR control 120. These buttons are used to reveal or hide a number of highlight regions that are aligned with respective menu options of the pull-down menu 300. FIG. 11 illustrates the process 1100 of successive display of the frames constituting the first and second video sequences, according to the direction of the time lines 1102 and 1104. The relationship between the sub-picture graphical overlay 804 and the corresponding “Save As” menu item 804′ of the pull-down menu 300 can be more easily appreciated.

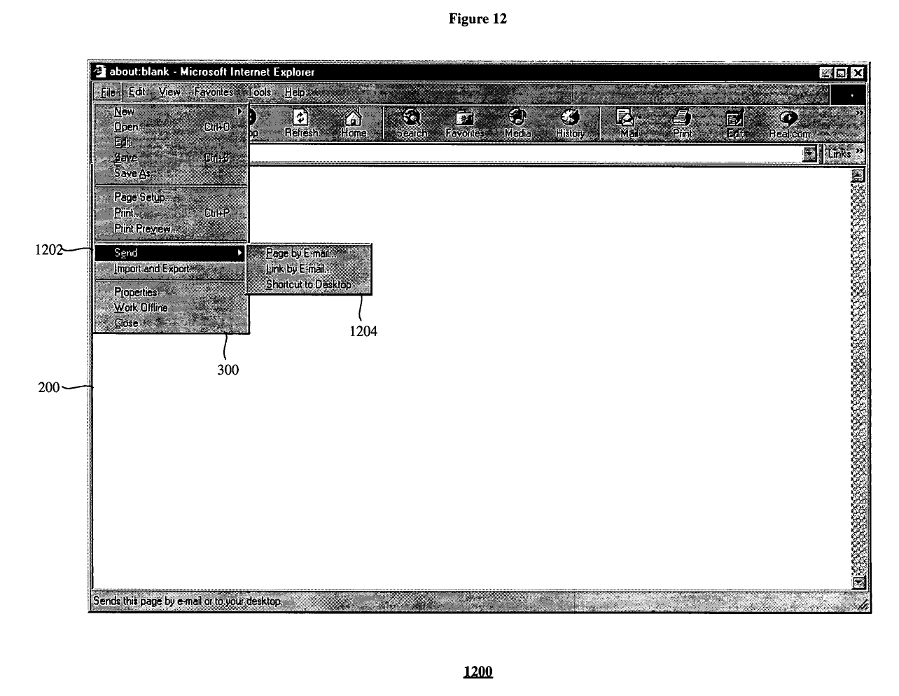

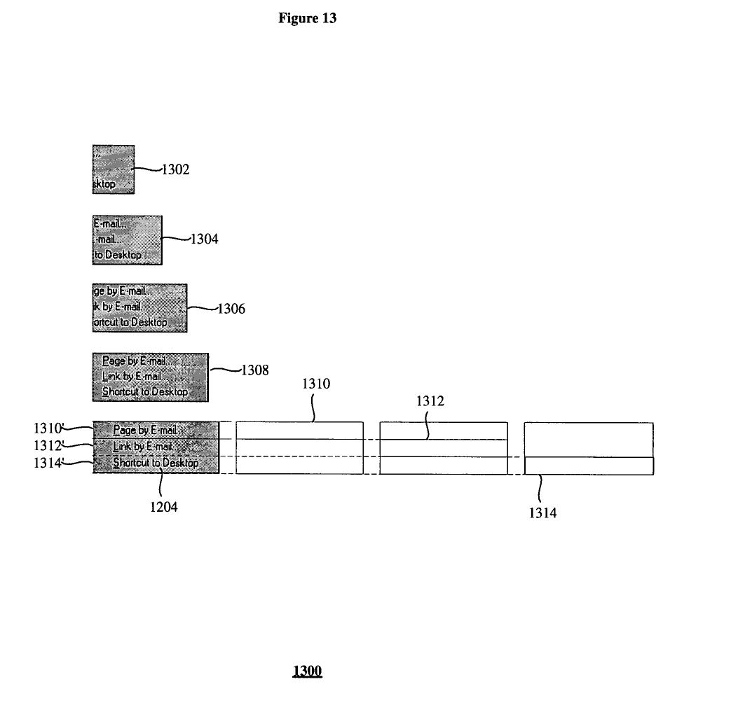

FIG. 12 illustrates a view 1200 of the application 200 with one menu item 1202 of the pull-down menu 300 having been invoked. It can be appreciated that this invocation has produced a further menu 1204. In preferred embodiments, the further menu 1204 is progressively displayed in a left-to-right manner in a similar process to the progressive display of the pull-down menu 300 itself. The authoring process to produce the data used in producing a video sequence having such a left-to-right menu needs to produce data 1300 such as, for example, that shown in FIG. 13. The left-to-right menu data 1300 comprises a number of portions 1302 to 1308 of the further menu 1204. Each portion 1302 to 1308 is progressively bigger or smaller than a succeeding or preceding portion respectively. Also shown, in a manner analogous to that of FIG. 8, are the sub-picture graphical overlays 1310 to 1314 that correspond to the respective menu items 1310′ to 1314′ of the further menu 1204. The data shown in FIG. 13 is used to produce video sequences for progressively expanding or contracting the further menu 1204 in a manner that is substantially similar to the process used to produce the first 602 and second 604 video sequences shown in FIG. 6.

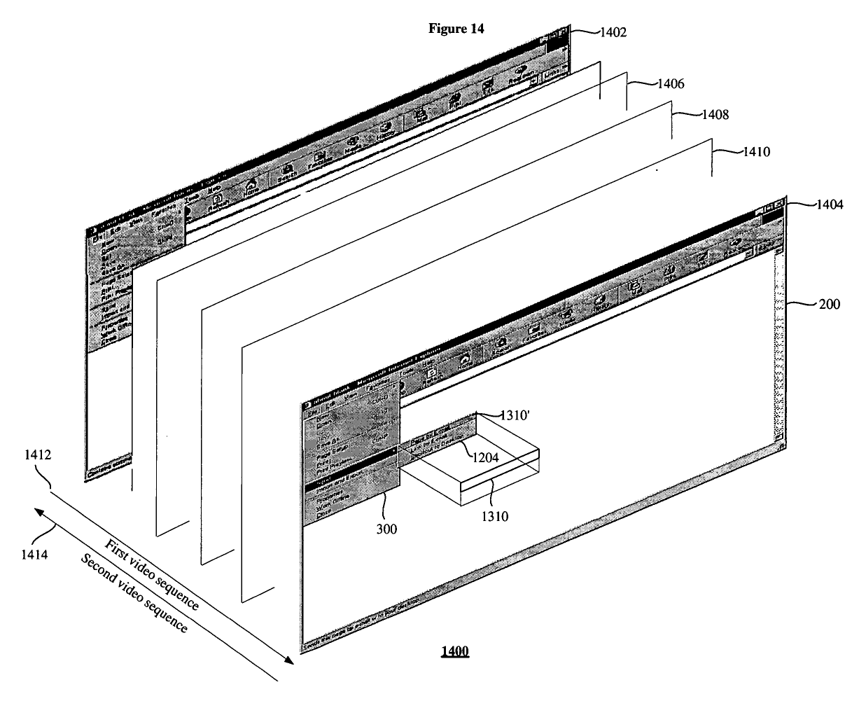

FIG. 14 illustrates, with greater clarity, the relationship 1400 between the further menu 1204 and the sub-picture graphical overlay 1310 for the “Page by E-mail” 1310′ menu item. It can be appreciated that the pull-down menu 300 has been invoked, followed by the selection of the “Send” menu item 1202, which has caused the display of the left-to-right menu 1204 and the corresponding sub-picture graphical overlay 1310. Again, the start frame 1402 and end frame 1404 are shown, together with intermediate frames 1406 to 1410, as constituting expansion and contraction video sequences according to the direction of the time lines 1412 and 1414 respectively.

It will be appreciated that the navigation data associated with the first video sequence 602 will include a link to the video sequence for expanding the further menu 1204 to give effect to that expansion should the “Send” menu item 1202 be invoked.

It will be appreciated from the above that the process of marshalling or producing a visual asset for displaying and using dynamic menus involves producing video sequences for both the expansion and contraction, that is, the display and hiding, of the pull-down menu together with navigation data linking the frames and/or video sequences, according to planned or predetermined user operations and sub-picture graphical overlay data and navigation data for controlling the display of the sub-picture graphical overlays.

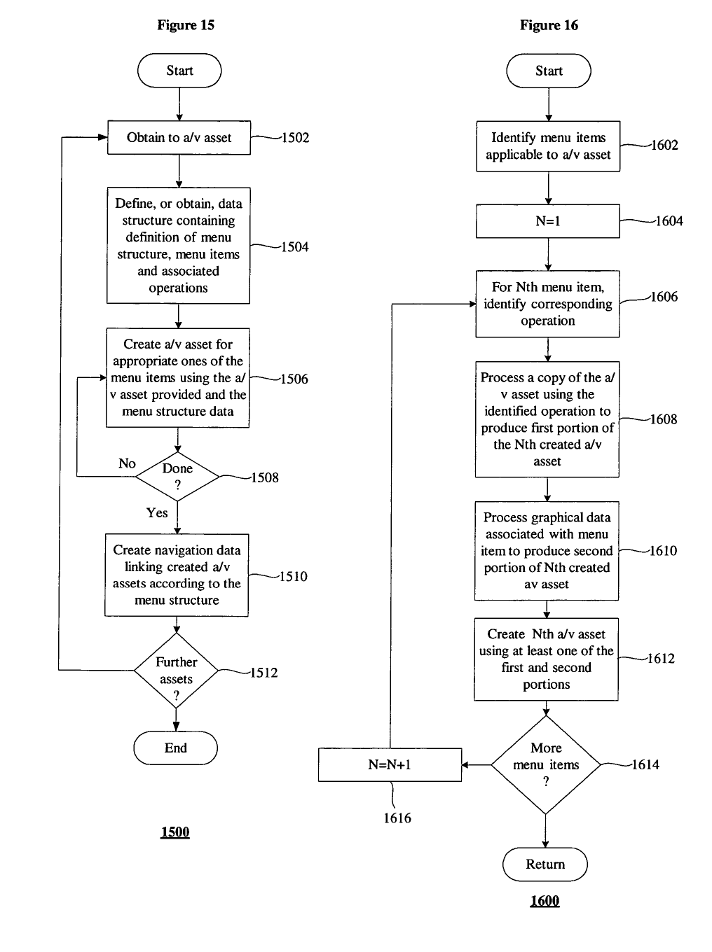

Referring to FIG. 15 there is shown a flowchart 1500 for producing visual assets according to an embodiment of the present invention. At step 1502, an original visual asset is provided or obtained. A data structure comprising a definition of a menu structure together with associated menus and menu items and operations related to those menu items is defined at step 1504. Such a data structure has been described above in relation to FIGS. 4 and 5. An asset is created, at step 1506 using appropriate menu items and their related operations as well as the originally provided video asset. It is determined at step 1508 whether or not all assets relating to the originally provided asset have been created. If the determination at step 1508 is negative, processing returns to step 1506 where a further asset is created, again, according to the needs or requirements defined by the menu structure defined in step 1504. Having created the necessary video assets from an original asset, navigation data linking the assets according to an intended navigational strategy, which is, again, defined by the menu structure, is created at step 1510. A test, performed at step 1512, determines whether or not there are further a/v assets to process. If the test is positive, processing continues at step 1502, where the next asset to be processed is obtained. If the test is negative, processing terminates.

FIG. 16 shows a flowchart 1600 that illustrates the steps undertaken in steps 1506 and 1508 of FIG. 15 in greater detail. The menu items applicable to a provided video asset are identified and counted at step 1602. A count, N, is set to 1 at step 1604. For the Nth menu item, the corresponding operation such as, for example, the operations 428 to 432 shown in FIG. 4, are identified. At step 1608 a copy of the originally provided video asset is processed using the appropriate operation identified at step 1606 to create at least a portion, or a first portion, of an intended Nth video asset.

At step 1610, the graphical data associated with the Nth menu item is processed to produce a second portion of the Nth video asset. The complete or whole of the Nth video asset is created using at least one of the first and second portions at step 1612. It is determined, at step 1614, whether there are more menu items to be processed for which corresponding video assets, derived from the originally provided video asset, are required. If the determination is positive, processing continues to step 1616 where N is incremented and control passes to step 1606, where the next menu item is considered. If the determination at step 1614 is negative, processing terminates or, more accurately, processing returns to step 1508 of FIG. 15. It will be appreciated by those skilled in the art that the menu structure defined in the data structure might comprise sub-menus. Therefore, the process of producing the assets for such a complex menu structure might require nested or recursive applications of the steps shown in the flowcharts.

Although the above embodiments have been described within the context of a DVD equivalent of Internet Explorer, embodiments of the present invention are not limited thereto. Embodiments can be realised in which the pull-down menus are implemented in any context. For example, the “application” might be intended to step through an album of photographs or video sequences and the menu items might control the display of those photographs or video sequences. Still further, it will also be appreciated that the pull-down menu stems from a corresponding menu bar item. However, the pull-down menu can be arranged to appear, at a predetermined screen position, in response to a user-generated event.

The above embodiments have been described with reference to creating video or visual assets. However, embodiments of the present invention are not limited to such an arrangement. Embodiments can be realised in which the assets processed and/or produced are audio-visual assets.

Although the above embodiments have been described in the context of dynamic menus, embodiments of the present invention are not limited to such an arrangement. Embodiments can be realised in which, for example, modal or modeless dialogue boxes, or other GUI elements, are emulated via correspond video sequences.

It will be appreciated that the video assets created in the above embodiments might use an image processing system or multimedia authoring system by which an author can create the assets. For example, to overlay menu image data on top of image or video data one skilled in the art might use Macromedia Flash, Macromedia Director or Adobe AfterEffects. Furthermore, the navigation data associated with such created assets might use the invention described in UK patent application no. GB 0309814.2 (filed 30 Apr. 2003 and claiming priority from UK Patent application no. GB 0209790.5) and U.S. patent application Ser. No. 60/383,825, the contents of which are incorporated herein for all purposes by reference and shown in appendix A.

Furthermore, it will be appreciated that the embodiments of the present invention are preferably implement, where appropriate, using software. The software can be stored on or in various media such as, for example, magnetic or optical discs or in ROMs, PROMs and the like.

For the avoidance of doubt, the phrase “one or more” followed by, for example, a noun comprises “one [noun]” and “two or more [nouns]”, that is, it comprises “at least one [noun]” and visa versa. Therefore, the phrase “one or more video sequences” comprises one video sequence and, similarly, the phrase “one or more original assets” comprises one original asset as well as both extending to “a plurality of video sequences” and “a plurality of original assets” respectively.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An asset authoring method comprising the steps of providing a data structure comprising data defining a menu structure having at least one menu having a respective number of menu items associated with a number of defined views of, or actions in relation to, a general visual asset; providing a visual asset; and creating, automatically, a number of visual assets using at least one of the visual asset provided and the data of the data structure; the visual assets created corresponding to respective views of the defined views of the visual asset provided or reflecting respective actions of the defined actions in relation to the visual asset provided.

2. An asset authoring method as claimed in claim 1 in which the step of providing the visual asset comprises the step of providing at least one of image data and a video sequence.

3. An asset authoring method as claimed in claim 1 in which the step of creating the number of visual assets comprises the step of deriving data from the provided visual asset to produce the number of visual assets.

4. An asset authoring method as claimed in claim 3 in which the step of deriving data from the provided visual asset comprises the step of copying data from the provided visual asset.

5. An asset authoring method as claimed in claim 3 in which the step of deriving data from the provided visual asset comprises the step of processing the data of the visual asset such that the number of visual assets comprises respective modified data of the provided visual asset.

6. An asset authoring method as claimed in claim 1 in which the step of creating the number of visual assets comprises the step of including, in selected visual assets of the number of visual assets, visual data representing views of selected menu items of the number of menu items.

7. An asset authoring method as claimed in claim 1 in which the step of creating the number of visual assets comprises the step of creating sub-picture data comprising data for at least one selectable graphical element associated with a respective menu item.

8. An asset authoring method as claimed in claim 7 in which the step of creating the sub-picture data comprises the step of creating, or providing, a number of selectable graphical elements associated with respective menu items.

9. An asset authoring method as claimed in claim 8 in which the step of creating the sub-picture data comprises the step of creating a mask for selectively displaying the number of selectable graphical elements.

10. An asset authoring method as claimed in claim 1 in which the step of creating the number of visual assets comprises the steps of associating a visual asset processing operation with selected menu items of the menu items; and deriving the data for the number of visual assets from the provided visual asset using respective visual asset processing operations.

11. An asset authoring method as claimed in claim 1 in which the step of providing the data structure comprises the step of defining image data or video data associated with a plurality of views of the menu.

12. An asset authoring method as claimed in claim 11 in which the step of defining image data or video data associated with the plurality of views of the menu comprises the step of creating image data or video data such that the plurality of views of the menu represent progressively expanding or contracting views of the menu.

13. An asset authoring method as claimed in claim 1, further comprising the step of creating navigational data associated with, or linking, the number of visual assets according to the menu structure to allow the number of visual assets to be accessed, played or displayed according to the menu structure.

14. An asset authoring method as claimed in claim 1, further comprising the step of providing a first number or plurality of visual assets; and creating, automatically, a second number of visual assets using the plurality of visual assets; the created visual assets corresponding to respective views of the defined views or to respective actions of the defined actions according to the menu structure.

15. An asset authoring method as claimed in claim 1 in which the step of providing the visual assets comprises the step of providing an audio-visual asset.

16. An asset authoring system comprising means to provide a data structure comprising data defining a menu structure having at least one menu having a respective number of menu items associated with a number of defined views of, or actions in relation to, a general visual asset; means to provide a visual asset; means to create, automatically, a number of visual assets using at least one of the visual assets provided and the data of the data structure; the visual assets created corresponding to respective views of the defined views of the visual asset provided or reflecting respective actions of the defined actions in relation to the visual asset provided.

17. An asset authoring system as claimed in claim 16 in which the means to provide the visual asset comprises means to provide at least one of image data and a video sequence

18. An asset authoring system as claimed in either of claim 16 in which the means to create the number of visual assets comprises means to derive data from the provided visual asset to produce the number of visual assets.

19. An asset authoring system as claimed in claim 18 in which the means to derive data from the provided visual asset comprises means to copy data from the provided visual asset.

20. An asset authoring system as claimed in claim 18 in which the means to derive data from the provided visual asset comprises means to process the data of the visual asset such that the number of visual assets comprises respective modified data of the provided visual asset.

21. An asset authoring system as claimed in claim 16 in which the means to create the number of visual assets comprises means to include, in selected visual assets of the number of visual assets, visual data representing views of selected menu items of the number of menu items.

22. An asset authoring system as claimed in claim 16 in which the means to create the number of visual assets comprises means to create sub-picture data comprising data for at least one selectable graphical element associated with a respective menu item.

23. An asset authoring system as claimed in claim 16 in which the means to create the sub-picture data comprises means to create, or provide, a number of selectable graphical elements associated with respective menu items.

24. An asset authoring system as claimed in claim 16 in which the means to create the sub-picture data comprises means to create a mask for selectively displaying the number of selectable graphical elements.

25. An asset authoring system as claimed in claim 16 in which the means to create the number of visual assets comprises means to associate a visual asset processing operation with selected menu items of the menu items; and means to derive the data for the number of visual assets from the provided visual asset using respective visual asset processing operations.

26. An asset authoring system as claimed in claim 16 in which the means to provide the data structure comprises means to define image data or video data associated with a plurality of views of the menu.

27. An asset authoring system as claimed in claim 16 in which the means to define the image data or the video data associated with the plurality of views of the menu comprises the means to create the image data or the video data such that the plurality of views of the menu represent progressively expanding or contracting views of the menu.

28. An asset authoring system as claimed in claim 16 further comprising means to create navigational data associated with, or linking, the number of visual assets according to the menu structure to allow the number of visual assets to be accessed, played or displayed according to the menu structure.

29. An asset authoring system as claimed in claim 16 further comprising means to provide a first number or plurality of visual assets; and means to create, automatically, a second number of visual assets using the plurality of visual assets; the created visual assets corresponding to respective views of the defined views or to respective actions of the defined actions according to the menu structure.

30. An asset authoring system as claimed in claim 16 in which means to provide the visual assets comprises means to provide an audio-visual asset.

31. A storage medium comprising at least visual content authored using a method, system, computer program or computer program product as claimed in claim 1.

32. A storage medium comprising data representing a video sequence comprising data to display a progressively variable or dynamic menu comprising a number of menu items following invocation of a selected menu item or receipt of a user generated event; and data representing sub-picture graphical elements for each menu item; each sub-picture graphical element having associated position data to mask the elements in predetermined positions relative to corresponding menu items when rendered in response to a user-generated event.

33. A storage medium as claimed in either of claims 32 in which the storage medium is an optical medium.

34. A storage medium as claimed in claim 32 in which the optical medium is a DVD product.

35. A storage medium as claimed in claim 32 in which the storage medium is a magnetic medium.

36. A storage medium as claimed in claim 32 in which the storage medium is a digital linear tape.

37. A system to manufacture a DVD product; the system comprising means to create a data carrier comprising data representing a video sequence comprising data to display a progressively variable or dynamic menu comprising a number of menu items following invocation of a selected menu item or receipt of a user generated event; and data representing sub-picture graphical elements for each menu item; each sub-picture graphical element having an associated maskable position relative to corresponding menu items when rendered in response to a user-generated event.

38. A system to manufacture a DVD product; the system comprising means to read a data carrier comprising data representing at least the set of visual assets created using a method, system, computer program, computer program product or storage medium as claimed in any preceding claim; and means to materially produce the DVD product using the data stored on the data carrier.

39. A DVD product comprising data representing a video sequence comprising data to display a progressively variable or dynamic menu comprising a number of menu items following invocation of a selected menu item or receipt of a user generated event; and data representing sub-picture graphical elements for each menu item; each sub-picture graphical element having an associated maskable position relative to corresponding menu items when rendered in response to a user-generated event.
